(19) United States
(12) Patent Application Publication
(10) Pub. No.: US 2011/0051630 A1
(43) Pub. Date: Mar. 3, 2011

(54) REPEATER FOR A TRUNKED RADIO NETWORK

(75) Inventor: Nicholas Richard PENNANCE, Rangiora (NZ)

(73) Assignee: TAIT ELECTRONICS LIMITED, Christchurch (NZ)

(21) Appl. No.: 12/870,840

(22) Filed: Aug. 29, 2010

Related U.S. Application Data
(60) Provisional application No. 61/238,769, filed on Sep. 1, 2009.

(30) Foreign Application Priority Data
Aug. 31, 2009 (NZ) 579364

(51) Int. Cl. H04B 7/14

(52) U.S. Cl. 370/279

(57) ABSTRACT

A repeater which enables portable radio terminals to operate outside the normal coverage area of a trunked radio network. The repeater combines two wireless transceivers which may simply be radio terminals coupled together in a vehicle, for example. One transceiver communicates control messages to and from the trunked network using a full or half duplex channel. The other transceiver communicates with the portable terminals using a half duplex or simplex channel. The link from the repeater to the network includes a generally continuous control channel while the link to the portable terminals is generally non continuous with intervals for messages from the terminals back to the repeater.

This application claims the benefit of U.S. Provisional Application 61/238,769 filed Sep. 1, 2009 and the priority of New Zealand Application NZ 579364 filed Aug. 31, 2009.

### BACKGROUND TO THE INVENTION

This invention relates to a repeater for a trunked radio network, in particular but not only to a mobile repeater which provides extended coverage for radio terminals such as hand portable radios. The repeater may also be used in a fixed radio station, and in either form may provide for wireless communication with other portable, mobile or fixed radio stations.

In this specification the term “radio terminal” means portable, mobile or fixed equipment which is authorised to receive wireless signals from base stations in a trunked network such as described by APCO 25. The term “repeater” means equipment which can convey wireless signals between base stations and radio terminals. Repeaters may be mobile, such as being mounted in a vehicle, or fixed, such as being mounted in a building or tunnel having a gap in local coverage, or located at the edge of an existing coverage area.

A trunked network provides a series of radio frequency RF channels for use by radio terminals. These channels are dynamically assigned to the terminals as required for various services, such as voice and data traffic, and then released once the particular service has been delivered. The network broadcasts messages relating to the available services over a control channel which is monitored by the terminals. Services are also requested by the terminals using messaging over the control channel, and if available, the services are provided by the network over traffic channels.

Radio channels are usually provided as either a single frequency on which terminals alternately transmit and receive signals, or as a frequency pair having both forward and reverse (or up-link and down-link) sub frequencies. Some radio terminals transmit and receive signals alternately using the frequency pair. More complex terminals containing a duplexer can use the pair to transmit and receive signals simultaneously without interference.

A full duplex communication link involves simultaneous transmission and reception of forward and reverse radio signals by a transceiver using a frequency pair. A half duplex link also uses a frequency pair but involves transmission of only a single forward or reverse signal at one time. A simplex link operates with a single frequency and also involves transmission of only a single signal at one time. Operation of a radio terminal in either a half duplex or simplex mode is commonly called “Push-to-Talk”.

Transmission schemes such as time division multiple access (TDMA) and frequency division multiple access (FDMA) may be implemented to provide multiple channels on a single frequency or frequency pair.

A variety of repeaters are known for trunked radio networks, such as vehicle range extenders which are used to provide services for portable terminals at the edge of network coverage, or in small areas within the network having limited local coverage. The services are often limited and the extender hardware may not be able to function as a normal radio. Examples are provided by U.S. Pat. No. 5,857,144, U.S. Pat. No. 5,179,720 and U.S. Pat. No. 6,141,533. In each case full duplex radio equipment is required for the repeater to usefully extend both control and traffic channels to radio terminals. The equipment is relatively expensive and requires relatively more power to be supplied. It can therefore be impractical for many radio systems.

### SUMMARY OF THE INVENTION

It is an object of the invention to provide a repeater which operates in a trunked radio network and which provides either a half duplex or simplex link to radio terminals, or at least to provide an alternative to existing repeaters.

In one aspect the invention resides in a repeater for a trunked radio network, including: a first transceiver for wireless communication with the trunked network, and a second transceiver coupled to the first transceiver for wireless communication with a radio terminal, wherein the first transceiver transmits and receives control signals on a full duplex or half duplex link with the trunked network, and the second transceiver transmits and receives corresponding control signals on a half duplex or simplex link with the radio terminal.

Preferably the control signals received by the first transceiver from the trunked network form a continuous control channel and the corresponding control signals transmitted by the second transceiver form a non-continuous control channel. The control signals transmitted by the second transceiver include relatively short bursts containing control messages separated by relatively long intervals for transmission of control messages by the radio terminal. The radio terminal is registered on the repeater which passes a corresponding registration message to the trunked network.

Preferably the second transceiver provides a composite control channel which carries either control signals or traffic. The traffic repeater channel is transparent for voice or data communication between the trunked network and the radio terminal.

Preferably the first and second transceivers are provided by a pair of radios coupled together and programmed to convert messages on a control channel broadcast by the trunked network into messages on a composite channel broadcast by the repeater.

In another aspect the invention resides in a method of operating a repeater to provide a composite control channel on a half duplex or simplex link, including: receiving control messages broadcast as a generally continuous signal by a trunked radio network, broadcasting corresponding control messages over the link to a radio terminal as a generally non continuous signal, and receiving control messages from the radio terminal over the link as a generally non continuous signal.

Preferably the method further includes transmitting the control messages as relatively short bursts between relatively long intervals, to form the non continuous signal to the radio terminal. The control messages from the radio terminal are received by the repeater as bursts during the intervals.

Preferably the method further includes ceasing transmission of control signals on the link between the repeater and the radio terminal once a traffic channel has been assigned, and passing traffic signals transparently between the network and the radio terminal.

Preferably the method further includes receiving a registration request from the radio terminal over the link, registering the radio terminal in a repeater database, and transmitting a corresponding registration message to the trunked network for registration in a network database.

In a further aspect the invention resides in a method of operating a radio terminal on a simplex or half duplex link with a repeater in a trunked radio network, including: receiving one or more repeater radio bursts on the link, containing control messages broadcast by the repeater, waiting for an interval between the repeater radio bursts, and transmitting a radio terminal burst on the link during the interval, containing control messages for the repeater.

Preferably the control messages from the repeater correspond to control messages received by the repeater from the trunked network and the control messages for the repeater are ultimately received by the trunked network. Once control messages from the repeater have ceased the terminal transmits and receives voice or data traffic to and from the trunked network over the link.

The invention also resides in a radio terminal which is programmed to implement a method as outlined above.

The invention further resides in a radio terminal for a trunked radio network, including a transceiver which is programmed to carry out the following steps: hunt for messages on a generally continuous control channel provided by the network, and in the absence of a continuous control channel, hunt for messages on a generally non continuous control channel provided by a repeater. The transceiver waits for intervals between control messages on the non continuous control channel, and transmits messages to the repeater during the intervals.

### LIST OF FIGURES

Preferred embodiments of the invention will be described with respect to the accompanying drawings, of which:

FIG. 1 shows the coverage area of several base stations and a repeater in a trunked radio network,

FIG. 2 shows conversion of a continuous control channel from a base station into a non-continuous control channel by the repeater,

FIG. 3 shows a pair of coupled transceivers which form the repeater,

FIG. 4 shows the main functionality of respective processors in the transceivers,

FIG. 5 outlines generation of a non continuous control channel by the repeater,

FIG. 6 outlines detection of the non continuous control channel by the radio terminal,

FIG. 7 shows the processes of registration and affiliation of a radio terminal through the repeater,

FIG. 8 shows the process of a network originated voice call through the repeater,

FIG. 9 shows the process of a terminal originated voice call through the repeater, and

FIG. 10 shows communication between multiple radio terminals using the repeater.

### DESCRIPTION OF PREFERRED EMBODIMENTS

Referring to the drawings it will be appreciated that the invention can be implemented in a range of different trunked radio networks and with a range of different repeaters and radio terminals. This embodiment primarily involves a mobile trunked repeater (MTR) and hand portable radio, and is described by way of example only.

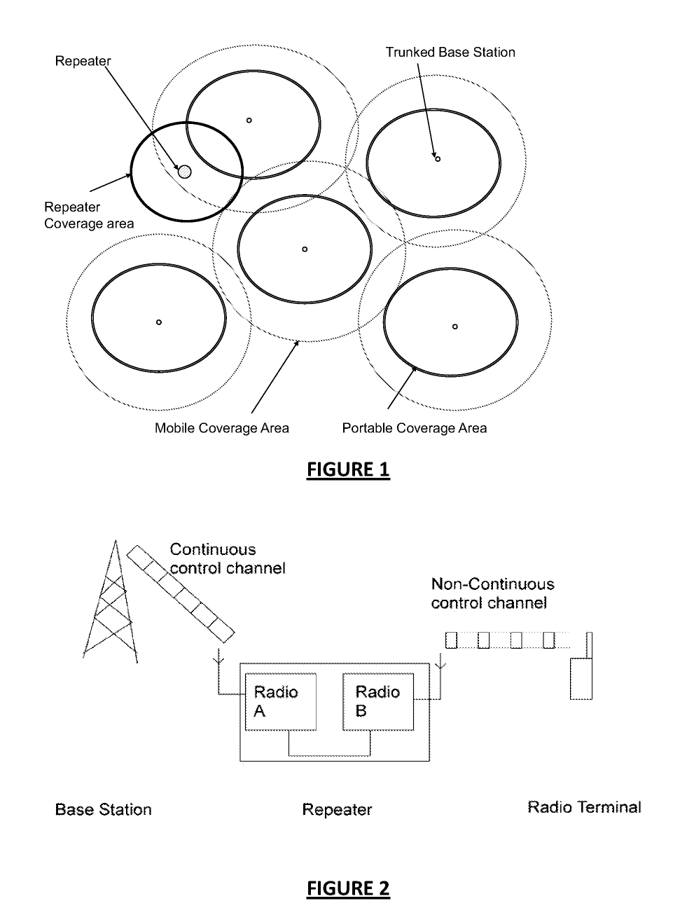

FIG. 1 schematically shows how a trunked network provides communication services over a coverage area formed by a number of adjacent base stations. The coverage of each base station is approximated by a pair of circles, with the inner circle representing the area in which a relatively low powered and less sensitive portable terminal is able to exchange RF signals with the base station, and the outer circle representing the range of radio signals for a relatively high powered mobile terminal, typically mounted in a vehicle. The coverage of a mobile repeater for portable terminals is approximated as a circular area which extends the area of an adjacent base station. A portable radio terminal can roam freely between the areas covered by the base stations and the area covered by the repeater. The repeater may take various other configurations, such as a fixed station which provides extended coverage for mobile terminals, for example, in which case the coverage areas would be represented differently in FIG. 1.

FIG. 2 schematically shows how the repeater in FIG. 1 may be constructed from a pair of radios A, B coupled together and programmed to receive services from the trunked network and to provide corresponding services for radio terminals within the local coverage area. The repeater provides a composite channel which carries either control messages or traffic, according to demand by the local terminals. Control messages relating to registration and call requests for example, are converted by the repeater. The services are then provided transparently through the repeater between the network and the local terminals. In this example, the repeater includes a mobile terminal A which is able to communicate normally with base stations in the trunked network, and a more limited terminal B which provides coverage for nearby portable terminals. Radio A may be a full duplex or half duplex trunking capable terminal and communicates with the network over a generally continuous control channel. Radio B need only have half duplex or simplex capability, and communicates with one or more local radio terminals using a generally non continuous control channel.

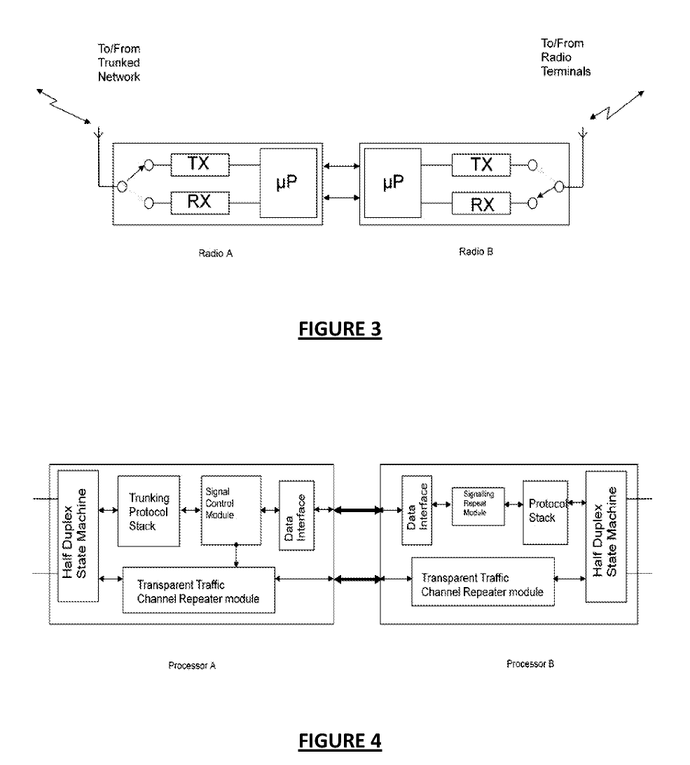

FIG. 3 indicates the main components of radios A, B in FIG. 2. Each is a transceiver having an antenna, with a transmitter TX and receiver RX for RF signals, under control of a micro processor which operates according to instructions stored in a respective memory (not shown). Other standard components of a typical radio terminal have been omitted for clarity. The radios are typically located side by side and wired together but could also be coupled using a wireless connection. Radio A is preferably also able to operate as an individual mobile radio in the usual way. In this example, neither radio includes a duplexer which would enable the respective transmitter and receiver to operate simultaneously through the single antenna to provide a full duplex communication link. Each includes a simple switch which connects either the transmitter or the receiver to the antenna for half duplex or simplex communication links. The repeater can therefore be constructed relatively cheaply, and supplied to a fleet of utility vehicles for example.

FIG. 4 indicates the repeater functions provided by software in the processors of FIG. 3. In this example both radios A, B include a module (termed the “half duplex state machine”) which controls the respective switch between transmitter and receiver to provide half duplex functionality, and a traffic module which conveys voice or data traffic transparently between local terminals and the network. Both radios include a respective protocol stack and a data interface for control signals. In this example the trunked network uses an industry standard protocol such as APCO 25 for transmitting signals to radio terminals and broadcasts messages on the control channel in a generally continuous fashion. The repeater uses a specialised protocol for transmitting signals, and broadcasts messages on the local control channel in a generally non continuous fashion, to allow intervals for return transmissions by local radio terminals. Radio A includes a module which enables conversion of control messages between the repeater and the network, and between the continuous and non continuous formats. Radio B then conveys the signalling between Radio A and the local terminals.

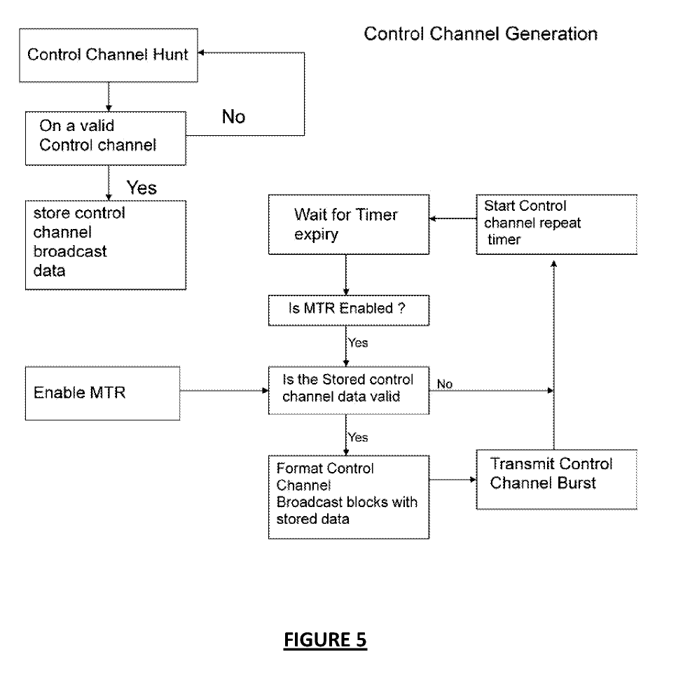

FIG. 5 outlines how the repeater in FIG. 2 generates the non continuous control channel according to the control channel provided by the trunked network, using APCO 25 as an example. A user initiates the Mobile Trunked Repeater (MTR) by operating a control on Radio A. Radio A hunts for the network control channel and stores the data which is received. Radio A then enables the MTR function of the linked transceivers. Radio B then transmits the converted data in bursts separated by a significant interval, typically several seconds, determined by a timer.

In APCO P25 the Control channel Broadcast messages of interest are NET_STS_BCST and RFSS_STS_BCST. The NET_STS_BCST contains information regarding the system while the RFSS_STS_BCST contains information regarding the current site. This broadcast data is saved locally on the repeater and retransmitted. The only change required to this data will be to the channel number of the control channel passed in the NET_STS and RFSS_STS messages.

Each repeater can operate on a unique frequency which can be outside of the operating frequency of the trunked network, effectively acting as a trunking crossband repeater. The repeater can create a local channel plan, based upon the operating frequency of Radio B. The transmit frequency of Radio B becomes the base frequency for this channel plan. The difference between transmit and receive becomes the TX offset (which would be 0 on a simplex link). A new Channel Identifier is created and added to become the NET_STS_BCST and RFSS_STS_BCST messages.

In a P25 Trunked network the MTRs generated control channel would then consist of bursts of IDEN_UP (or IDEN_UP_VU) depending upon the band, RFSS_STS_BCST—with the channel set to point at the newly defined IDEN_UP and channel number 0, and NET_STS_BCST—again with the channel set to point at the newly defined IDEN_UP and channel number 0. These three blocks would then be repeated on a regular basis when the repeater was idle.

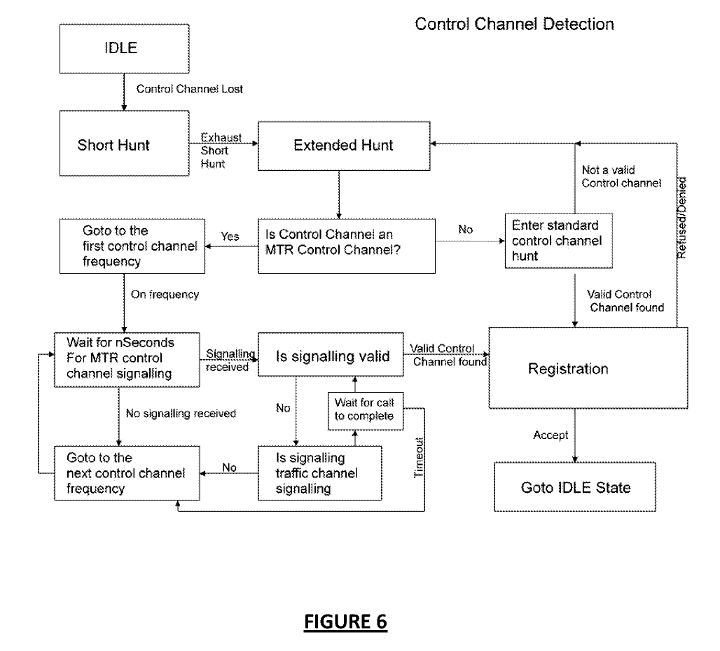

FIG. 6 outlines how the portable radio terminal in FIG. 2 moves from direct communication with a base station in the trunked network into indirect communication through the repeater. The terminal is typically a transceiver, such as those in FIG. 4, having an antenna, with a transmitter TX and receiver RX for RF signals, under control of a micro processor which operates according to instructions stored in a respective memory. On losing normal coverage, the terminal enters a control channel hunt state, looking for a continuously transmitted control channel which contains system data matching the data which was initially programmed into the terminal (in P25 terms System ID and WACNID). The repeater control channel is non continuous but contains all the necessary information for the terminal to decode the channel as originating from a valid trunked site. The special format of the repeater control channel is identified as being valid when the terminal is initially programmed, although identification is preferably also possible via the repeater signalling alone. In particular, the terminal is able accept a relatively long delay between bursts of data on the repeater control channel.

The repeater control channel is a repeating transmission of the three message blocks described above. The transmission takes approx 120 ms and should occur at an interval of 4 to 5 seconds in order for the hunting time required by a terminal to be practical. After every interval the repeater will transmit the control channel burst for approximately 120 ms. The interval is then available for transmissions by the radio terminal to the repeater.

An initial busy check is first required to access the control channel, typically by RSSI signal detection or in a digital system by a suitable form of digital signal detection. If a signal is detected then the transmitting terminal will check again after a period of time. The recheck period should be long enough to allow completion of a control channel burst. If the channel is again busy, a check for traffic channel signalling involving another terminal is required. Access is refused if traffic is present. Otherwise the access is cancelled and a further initial busy check occurs after a random time. The transmission request should be denied after a maximum number of retries. If busy is not detected then the transmission request can be made.

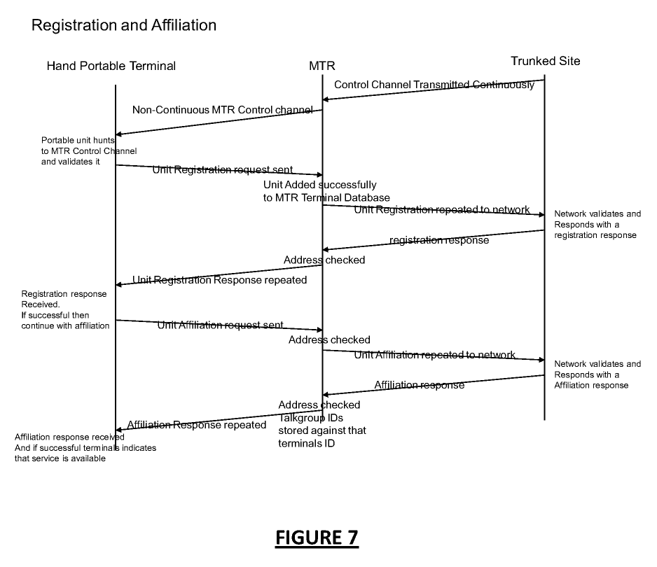

FIG. 7 indicates how a radio terminal registers on the trunked network once a repeater control channel has been found and validated. The terminal cannot use the repeater until registration has been successful. The terminal first sends a registration request as if communicating directly with the network (in P25 systems the request is U_REG_REG). The repeater checks whether the Unit ID is already recorded and if so, the records are updated and the request is passed to the network. If the UnitID is not known by the repeater then a new record is created, if space permits. There will be insufficient space once a maximum number of terminals have been recorded and subsequent requests will be denied. Once the request has been sent to the network the repeater then monitors the control channel for a response addressed the terminal. The response is recorded and repeated unchanged to the terminal. All subsequent control channel messages having the Unit ID relayed unchanged to the terminal. The repeater itself must first register using a similar process.

FIG. 7 also indicates how a radio terminal may affiliate with a talkgroup for voice calls. An affiliation request is sent from the terminal to the repeater. If the terminal is registered the request is passed on to the network. Otherwise the repeater returns a message requiring that the terminal send a request for registration. A response from the network is recorded (in P25 that would be the Affiliated Talkgroup and Announcement Talkgroup) and passed back to the terminal. All control channel messages addressed to either the terminal (or the repeater) will be received and processed, and messages for terminals will be repeated. The repeater will also monitor all Voice call announcements that are either addressed directly to terminals registered through the repeater, or that are addressed to talkgroups to which the registered terminals or the repeater are affiliated.

A voice call can originate in the network, from a radio terminal connected through the repeater, or from the repeater itself. Fully transparent voice paths are preferable so that any encryption can be maintained end-to-end. The same functionality should be available to a terminal as if connected directly to the network. All proceed to talk tones should be played as normal. If the network queues a call then the user will be alerted and when the network releases the queue the user will know and the call will continue. If no resources are available to make the call the network will send a call denied message which will also be passed on by the repeater and the terminal will be able to indicate to the user that the call cannot be made. The user experience when using the terminal would be the same as that when connected directly to the network.

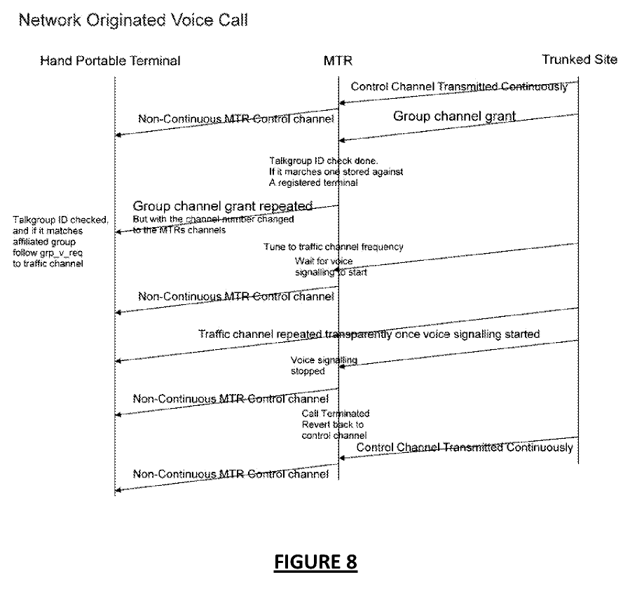

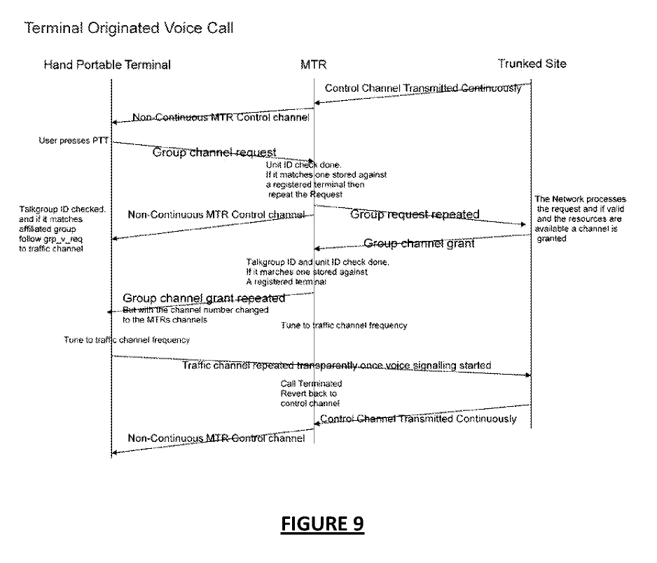

FIG. 8 indicates how a voice call may originate from a terminal in the network. The repeater will be monitoring all of the signalling which is transmitted by a base station on the network. If the repeater receives a voice call request, or an update to an address, both unit ID and talkgroup ID will be matched against the registered addresses and affiliated groups of the repeater and the radio terminals which have been registered through the repeater. In the case of a group call announcement, the Group Voice Channel Grant (GRP_V_CH_GRANT) will be passed through the repeater. Message data will be modified with the repeater channel identifier and channel number relevant to the radio terminal or terminals. The repeater follows the channel grant to the designated channel and waits for voice traffic to be received, but continues sending the control channel until voice traffic is received. Once valid voice signals are received the repeater will enter a transparent mode and simply repeat the voice traffic to and from the radio terminal. When voice signalling ceases the repeater recommences the non continuous control channel. A terminal monitoring the repeater signal will initially receive channel grant and if the group information is valid, will follow the grant to the designated channel (being the channel created by the repeater).

FIG. 9 indicates how a voice call may originate from a registered radio terminal through the repeater. The user would press PTT which causes the terminal to send a Group Voice Channel Request (GRP_V_REQ), as if connected directly to the trunked network. The request is received and checked by the repeater. If the request is not valid the repeater asks the terminal to reregister (U_REG_CMD). If valid the request is repeated to the network. The request is granted by the network if resources are available. A Group Voice Channel Grant message is sent from the network addressed to the requesting unit (the radio terminal) indicating the group address and a traffic channel. The repeater receives the grant and determines that the address matches that of the registered radio terminal, and that the group address matches a recorded affiliation. The repeater changes the channel number to the repeater channel identity and channel number, and repeats the grant to the terminal. The grant is received by the terminal as if directly from the network. The terminal tunes to the channel number and starts transmitting a voice signal, indicating that the user could proceed to talk, typically by playing a suitable tone. The repeater enters transparent mode and repeats traffic from the terminal to the traffic channel assigned by the network. When the user releases PTT the terminal stops transmitting and the repeater returns to generating the control channel. The repeater is able to avoid a subsequent re-entry process if the request and grant reoccur for the same terminal.

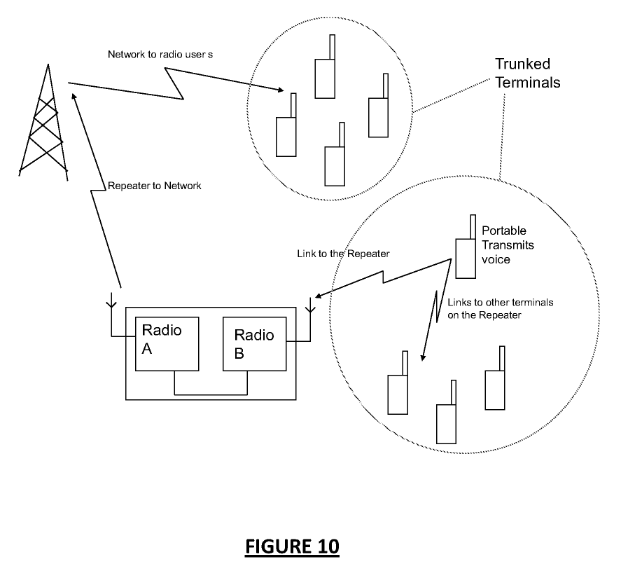

FIG. 10 shows multiple radio terminals communicating through a single repeater, with each terminal operating independently, possibly in different talkgroups. Any number of terminals can register with the repeater, and use a single channel, up to a preset maximum. An increasing number of terminals will increase the likelihood that a call will be missed. Terminals that are part of the same talkgroup are able to communicate with each other through the repeater, and also to other terminals which are connected directly to the network. If the repeater channel is a simplex link then traffic both to and from the repeater would be received directly by all terminals and need not be repeated.

In the case of a mobile repeater carried by a vehicle, the repeater registers on the most suitable trunked site and re-registers as required when the vehicle moves, either by a location registration process or a full registration. A portable radio terminal registered through the repeater is also registered on the trunked site and is responsible for any update which may be required. When the mobile repeater moves to a new site the RFSS_STS_BCST message is updated. A corresponding message on the repeater control channel contains the new site details, as if the portable terminal had itself migrated on the network. Portable terminals will receive the change in RFSS_STS_BCST, and proceed to re-register in the new site. The new registration will be passed to the network by the repeater to be recorded by the network controller as if the terminal was directly connected. A randomisation routine may be required for registration requests from multiple terminals to minimise the chance of collisions. A portable terminal which moves outside the coverage of a repeater will hunt for a new control channel and reregister either with another repeater or directly with a trunked site.

A range of applications and variations will be apparent to a skilled reader, such as a relatively lower power repeater using solar power. The repeater may also be connected to the network using IP rather than an RF link.

1. A repeater for a trunked radio network, including:
a first transceiver for wireless communication with the trunked network, and a second transceiver coupled to the first transceiver for wireless communication with a radio terminal,
wherein the first transceiver transmits and receives control signals on a full duplex or half duplex link with the trunked network, and the second transceiver transmits and receives corresponding control signals on a half duplex or simplex link with the radio terminal.

2. A repeater according to claim 1 wherein the control signals received by the first transceiver from the trunked network form a continuous control channel and the corresponding control signals transmitted by the second transceiver form a non-continuous control channel.

3. A repeater according to claim 1 wherein the control signals transmitted by the second transceiver include relatively short bursts containing control messages separated by relatively long intervals for transmission of control messages by the radio terminal.

4. A repeater according to claim 1 wherein the second transceiver provides a composite control channel which carries either control signals or traffic.

5. A repeater according to claim 4 wherein the channel is transparent for voice or data communication between the trunked network and the radio terminal.

6. A repeater according to claim 1 wherein the radio terminal is registered on the repeater which passes a corresponding registration message to the trunked network.

7. A repeater according to claim 1 wherein the second transceiver provides one or more frequencies for use by the radio terminal which are different to frequencies provided by the trunked network.

8. A repeater according to claim 1 wherein the first and second transceivers are provided by a pair of radios coupled together and programmed to convert messages on a control channel broadcast by the trunked network into messages on a composite channel broadcast by the repeater.

9. A method of operating a repeater to provide a composite control channel on a half duplex or simplex link, including:
receiving control messages broadcast as a generally continuous signal by a trunked radio network,
broadcasting corresponding control messages over the link to a radio terminal as a generally non continuous signal, and
receiving control messages from the radio terminal over the link as a generally non continuous signal.

10. A method according to claim 9 further including transmitting the control messages as relatively short bursts between relatively long intervals, to form the non continuous signal to the radio terminal.

11. A method according to claim 9 wherein the control messages from the radio terminal are received by the repeater as bursts during the intervals.

12. A method according to claim 9 further including ceasing transmission of control signals on the link between the repeater and the radio terminal once a traffic channel has been assigned, and passing traffic signals transparently between the network and the radio terminal.

13. A method according to claim 9 further including receiving a registration request from the radio terminal over the link, registering the radio terminal in a repeater database, and transmitting a corresponding registration message to the trunked network for registration in a network database.

14. A method of operating a radio terminal on a simplex or half duplex link with a repeater in a trunked radio network, including:
receiving one or more repeater radio bursts on the link, containing control messages broadcast by the repeater,
waiting for an interval between the repeater radio bursts, and
transmitting a radio terminal burst on the link during the interval, containing control messages for the repeater.

15. A method according to claim 14 wherein the control messages received from the repeater correspond to control messages received by the repeater from the trunked network, and the control messages transmitted for the repeater are retransmitted by the repeater for the trunked network.

16. A method according to claim 14 wherein once control messages from the repeater have ceased the terminal transmits and receives voice or data traffic to and from the trunked network over the link.

17. A radio terminal for a trunked radio network, including a transceiver which is programmed to carry out the following steps:
hunt for messages on a generally continuous control channel provided by the network,
and in the absence of a continuous control channel,
hunt for messages on a generally non continuous control channel provided by a repeater.

18. A radio terminal according to claim 17 wherein the transceiver is further programmed to carry out the following steps:
wait for intervals between control messages on the non continuous control channel, and
transmit messages to the repeater during the intervals.

19. A radio terminal according to claim 17 wherein the transceiver is further programmed to carry out the following steps:
in the presence of a control channel provided by the network, register directly on the network, and
in the presence of a control channel provided by the repeater, register on the network indirectly through the repeater.

20. A radio terminal according to claim 17 wherein the control channel provided by the network is a full duplex link and the control channel provided by the repeater is a half duplex or simplex link.
